(19) United States
(12) Patent Application Publication
(10) Pub. No.: US 2020/0288415 A1
(43) Pub. Date: Sep. 10, 2020

(54) SYSTEMS AND METHODS FOR RECONNECTING A DROPPED WIRELESS NETWORK NODE

(71) Applicant: Honeywell International Inc., Morristown, NJ (US)

(72) Inventors: Suneel Kunkati, Bangalore (IN); RajeshBabu Nalukurthy, Bangalore (IN); Sivasankar Mathuraju, Bangalore (IN); Kanaka Nagendra Prasad Naraharisetti, Bangalore (IN); Rajesh Kumar Kanakam, Bangalore (IN)

(21) Appl. No.: 16/294,270

(22) Filed: Mar. 6, 2019

(51) Int. Cl. H04W 52/44; H04W 52/36; H04W 76/19

(52) U.S. Cl. CPC H04W 52/44; H04W 76/19; H04W 52/367

(57) ABSTRACT

Systems and methods for reconnecting a dropped wireless network node can include a wireless network that includes a gateway device, a parent node, a child node of the parent node, and a neighboring node of the child node. The child node or the gateway device can identify the child node disconnecting from the wireless network, cause a transmission of a reconnection message from one node to another node at a first transmit power level, cause an incremental increase of the first transmit power level to a second transmit power level when the transmission of the message at the first transmit power level fails to reconnect the child node to the wireless network, and cause a transmission of the reconnection message from the one node to the another node at the second transmit power level.

### FIELD

The present invention relates generally to systems and methods for wireless network communication. More particularly, the present invention relates to systems and methods for reconnecting a dropped wireless network node to a wireless network.

### BACKGROUND

Security systems are known to detect threats within a secured area, and such threats can include events that represent a risk to human safety or a risk to assets.

Security systems typically include one or more security sensors that detect the threats within the secured area. For example, smoke, motion, and/or intrusion sensors can be distributed throughout the secured area in order to detect the threats. However, when the one or more security sensors communicate wirelessly, wireless communication by the one or more security sensors can be interrupted due to interference or poor wireless signal strength.

In view of the above, there is a continuing, ongoing need for improved systems and methods.

### BRIEF DESCRIPTION OF THE DRAWINGS

FIG. 1 is a block diagram of a system in accordance with disclosed embodiments;

FIG. 2 is a flow diagram of a method in accordance with disclosed embodiments;

FIG. 3 is a flow diagram of a method in accordance with disclosed embodiments; and

FIG. 4 is a flow diagram of a method in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for reconnecting a dropped wireless network node in a wireless network. In some embodiments, the dropped wireless network node can incrementally increase its transmit power until the dropped wireless network node is able to reconnect to a parent node or a neighboring node in the wireless network. As used herein, the term “dropped wireless network node” can be defined as any wireless network node in the wireless network that is not connected to any other wireless network node in the wireless network.

In some embodiments, the wireless network can include a mesh network, and each wireless network node within the mesh network can connect to two parent nodes for redundancy. When one wireless network node drops from the wireless network to become a dropped wireless network node, the dropped wireless network node can initially attempt to reconnect to the wireless network after a predetermined period of time by transmitting a reconnection signal at a transmit power level of the dropped wireless network node that is equal to a baseline level (e.g. a rescue mode). However, if the dropped wireless network node is unable to reconnect to the wireless network via the rescue mode, then the dropped wireless network node can enter a special mode in which the dropped wireless network node can attempt to reconnect to the wireless network by periodically transmitting the reconnection signal to the parent nodes while incrementally increasing the transmit power level of the dropped wireless network node to increased levels.

In some embodiments, one or both of the parent nodes (or a neighboring node) can also enter the special mode responsive to detecting a child node disconnecting therefrom and/or responsive to a wireless gateway device detecting the child node disconnecting from the wireless network and instructing that one of the parent nodes (or the neighboring node) to enter the special mode. In the special mode, one of the parent nodes (or the neighboring node) can attempt to reconnect to the dropped wireless network node (e.g. the child node) by incrementally increasing the transmit power of that one of the parent nodes (or the neighboring node) to the increased levels.

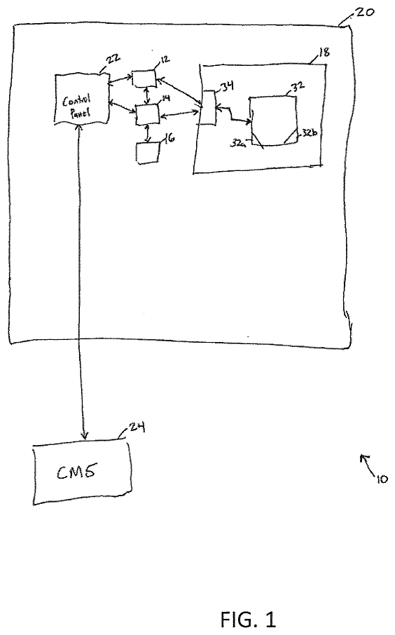

FIG. 1 is a block diagram of a security system 10 in accordance with disclosed embodiments. As seen in FIG. 1, the security system 10 can include one or more wireless nodes 12, 14, 16, 18. In some embodiments, each of the wireless nodes 12, 14, 16, 18 can include security sensors that monitor a secured area 20 for threats, and in some embodiments, each of the wireless nodes 12, 14, 16, 18 can include intrusion, camera, motion, fire, smoke, and gas detectors. Each of the wireless nodes 12, 14, 16, 18 can communicate with a control panel 22 and each other, and the control panel 22 can monitor for activation of the wireless nodes 12, 14, 16, 18.

In some embodiments, the control panel 22 may transmit an alarm message to a central monitoring station 24 upon activation of one of the wireless nodes 12, 14, 16, 18. The central monitoring station 24 may respond by summoning the appropriate help. For example, if the one of the wireless nodes 12, 14, 16, 18 activated detects a fire, then the central monitoring station 24 may summon a local fire department. Alternatively, if the one of the wireless nodes 12, 14, 16, 18 activated detects an intrusion, then the central monitoring station 24 may summon the police.

As seen in FIG. 1, the wireless nodes 12, 14, 16, 18 can form a mesh network, and in some embodiments, each of the wireless nodes 12, 14, 16, 18 in the mesh network can have two parent nodes such that each of the wireless nodes 12, 14, 16, 18 can transmit data to both of its parent nodes. For example, in FIG. 1, both the wireless node 12 and the wireless node 14 can be the parent nodes of the wireless node 18. Similarly, both the wireless node 14 and the control panel 22 can be the parent nodes of the wireless node 12. It is to be understood that the wireless node 16 can also have two parent nodes, but only one of the parent nodes (the wireless node 14) is illustrated.

Each of the wireless nodes 12, 14, 16, 18 can include control circuitry 32, which can include a programmable processor 32a and executable control software 32b as would be understood by one of ordinary skill in the art. The executable control software 32b can be stored on a transitory or non-transitory computer readable medium, including, but not limited to local computer memory, RAM, optical storage media, magnetic storage media, and the like. In some embodiments, the control circuitry 32, the programmable processor 32a, and the executable control software 32b can execute and control some of the methods disclosed herein. Furthermore, each of the wireless nodes 12, 14, 16, 18 can include a wireless transceiver 34 for communicating with other ones of the wireless nodes 12, 14, 16, 18.

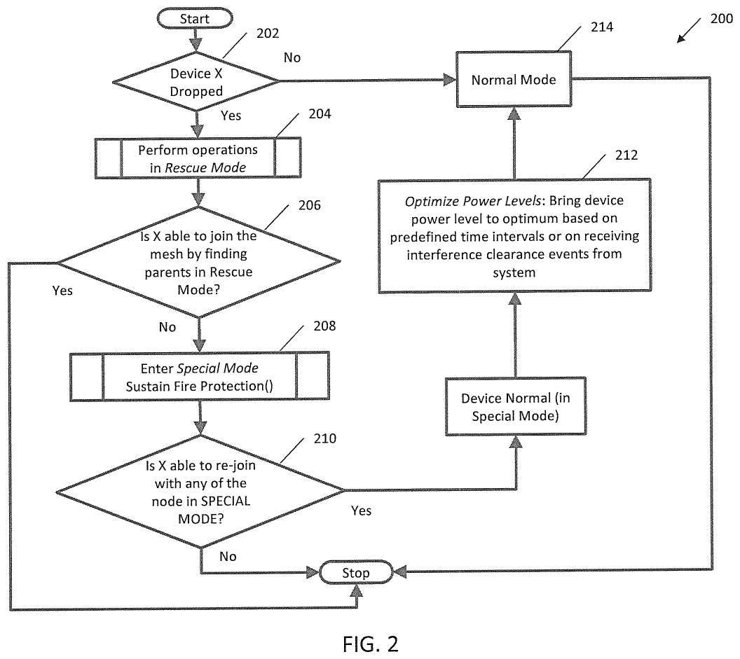

FIG. 2 is a flow diagram of a method 200 in accordance with disclosed embodiments. As seen in FIG. 2, the method 200 can include a wireless node (e.g. one of the wireless nodes 12, 14, 16, 18) determining whether the wireless node has lost a connection with both of its parent nodes (e.g. whether the wireless node has been dropped from a wireless network), as in 202. If the wireless node determines that the wireless node has the connection with at least one of its parent nodes as in 202 (e.g. the wireless node is connected to the wireless network), then the method 200 can include the wireless node operating in a normal mode, as in 214. For example, the normal mode may include the wireless node detecting a fire when the wireless node includes a smoke or fire detector.

However, when the wireless node determines that the wireless node has lost the connection with both of its parent nodes as in 202, the method 200 can include the wireless node entering a rescue mode to facilitate the wireless node reconnecting to one of its parent nodes, as in 204. In some embodiments, in the rescue mode, the wireless node can wait a predetermined period of time and before attempting to reconnect the wireless node with its parent nodes. Then, the method 200 can include the wireless node determining whether the wireless node was able to reconnect with its parent nodes, as in 206. If the wireless node determines that the wireless node reconnected to at least one of its parent nodes as in 206, then method 200 can terminate.

However, if the wireless node determines that the wireless node failed to reconnect to both of its parent nodes as in 206, then the method 200 can include the wireless node entering a special mode (e.g. a sustain fire protection mode), as in 208. In some embodiments, in the special mode, the wireless node can incrementally increase a transmit power level of signals transmitted from the wireless node. For example, the wireless node can repeatedly increase its transmit power level until a reconnection with the wireless network is established or until a maximum level of the transmit power level is reached. In some embodiments, after reaching the maximum level of the transmit power level, the wireless node can reset its transmit power level to a baseline level. Additionally, in some embodiments, in the special mode, the wireless node can transmit and receive only alarm messages and trouble messages, thereby conserving battery power.

After operating in the special mode as in 208, the method 200 can include the wireless node determining whether the wireless node was able to reconnect to another node (e.g. one of its parent nodes or a neighbor node) in the wireless network, as in 210. If the wireless node determines that the wireless node failed to reconnect to another node in the wireless network as in 210, then the method 200 can terminate.

However, if the wireless node determines that the wireless node was reconnected to another node in the wireless network as in 210, then the method 200 can include the wireless node operating normally in the special mode and optimizing its transmit power level, as in 212. Finally, the method 200 can include the wireless node entering the normal mode, as in 214.

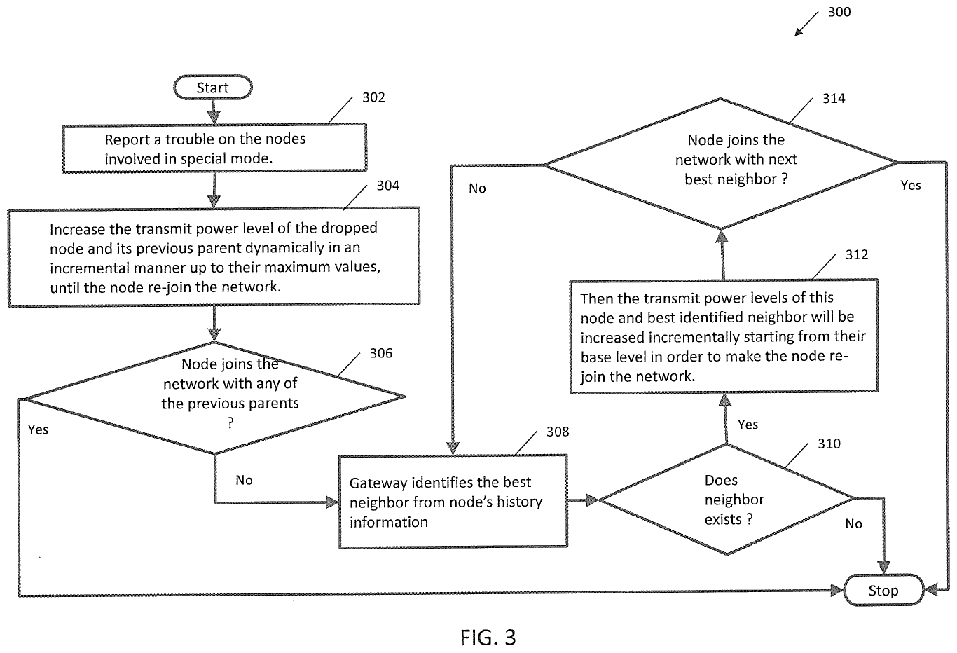

FIG. 3 is a flow diagram of a method 300 in accordance with disclosed embodiments. As seen in FIG. 3, the method 300 can include a wireless gateway device (e.g. the control panel 22) receiving a trouble message, as in 302. For example, the wireless gateway device can receive the trouble message responsive to a parent node detecting a disconnection from a child node and determining that the child node has disconnected from a wireless network.

Then, the method 300 can include the wireless gateway device instructing the parent node to incrementally increase a transmit power level of signals transmitted from the parent device, as in 304. For example, the parent node can repeatedly increase its transmit power level until a reconnection with the child node is established or until a maximum level of the transmit power level is reached. After reaching the maximum level of the transmit power level, the gateway device can instruct the parent node to reset its transmit power level to a baseline level.

Then, the method 300 can include the wireless gateway device determining whether the parent node was able to reconnect to the child node, as in 306. If wireless gateway device determines that parent node reconnected to the child node as in 306, then the method 300 can terminate.

However, if the wireless gateway device determines that the parent node failed to reconnect to the child node as in 306, then the method 300 can include the wireless gateway device identifying a best neighboring node of the child node, as in 308. For example, in some embodiments, the wireless gateway device can store a list of parent nodes for the child node, a list of neighboring nodes for the child node, and a respective signal strength for each of the parent nodes and each of the neighboring nodes received by the child node during initial registration of the child node. In some embodiments, the best neighboring node of the child node identified as in 308 can have a strongest signal strength of each of the neighboring nodes received by the child node during the initial registration that has not yet attempted to connect to the child node while the child node is disconnected from the wireless network.

Then, the method 300 can include the wireless gateway device determining whether the best neighboring node identified as in 308 exists in the wireless network, as in 310. If the wireless gateway device determines that the best neighboring node fails to exist in the wireless network as in 310, then the method 300 can terminate or include again identifying the best neighboring node of the child node, as in 308.

However, if the wireless gateway device determines that the best neighboring node exists in the wireless network as in 310, then the method 300 can include the wireless gateway device instructing the best neighboring node to incrementally increase a transmit power level of signals transmitted from the best neighboring node, as in 312. For example, the best neighboring node can repeatedly increase its transmit power level until a connection with the child node is established or until the maximum level of the transmit power level is reached. After reaching the maximum level of the transmit power level, the gateway device can instruct the parent node to reset its transmit power level to the baseline level.

Then, the method 300 can include the wireless gateway device determining whether best neighboring node was able to connect to the child node, as in 314. If the wireless gateway device determines that the best neighboring node connected to the child node as in 314, then the method 300 can terminate.

However, if the wireless gateway device determines that the best neighboring node failed to connect to the child node as in 314, then the method 300 can include the wireless gateway device again identifying the best neighboring node of the child node, as in 308. In accordance with disclosed embodiments, incrementally increasing a transmit power level as in 208, 304, and 312 can include incrementing the transmit power level in predetermined steps or in a predetermined number of steps. For example, in some embodiments, a first one of the predetermined steps can be a predetermined number of dBs less than a next one of the predetermined steps. Additionally or alternatively, in some embodiments, the predetermined number of steps can include low, medium, and high levels, and the method 200 and the method 300 can include incrementally increasing the transmit power level from a baseline level to the low level, from the low level to the medium level, and from the medium level to the high level (a maximum level) as in 208, 304, and 312, as necessary until a child node connects to a parent node or a neighboring node in a wireless network.

It is to be understood that the method 200 and the method 300 can be executed simultaneously. For example, when a child node is dropped from a wireless network, the child node can execute the method 200 while a wireless gateway device, a parent node of the child node, and/or neighboring nodes of the child node can execute the method 300 in an attempt to reconnect the child node to the wireless network.

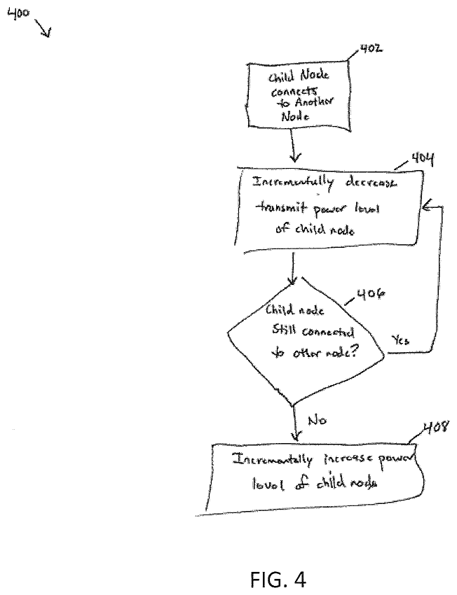

FIG. 4 is a flow diagram of a method 400 in accordance with disclosed embodiments and illustrates any wireless node (e.g. a child node, a parent node, or a neighboring node) optimizing its transmit power level. As seen in FIG. 4, the method 400 can include the wireless node connecting to another node (e.g. the child node connecting to the parent node or the neighboring node), as in 402, incrementally decreasing its transmit power level, as in 404, and determining whether the wireless node remains connected to the other node, as in 406.

If the wireless node determines that the wireless node remains connected to the other node as in 406, then the method 400 can include the wireless node continuing to incrementally decrease its transmit power level, as in 404. However, if the wireless node determines that the wireless node has disconnected from the other node as in 406, then the method 400 can include the wireless node increasing its transmit power level by one increment, as in 408, for example, to the transmit power level at which the wireless node last confirmed a connection to the other node.

Although a few embodiments have been described in detail above, other modifications are possible. For example, the steps described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A method comprising:
a child node determining that the child node has disconnected from a wireless network such that the child node has lost a connection with at least two other nodes in the wireless network;
the child node transmitting a reconnection message to another node in the wireless network at a first transmit power level;
the child node incrementally increasing the first transmit power level to a second transmit power level when the child node fails to reconnect to the wireless network responsive to the child node transmitting the reconnection message at the first transmit power level; and
the child node transmitting the reconnection message at the second transmit power level,
wherein the second transmit power level is higher than the first transmit power level.

2. The method of claim 1 wherein the first transmit power level is a baseline level.

3. The method of claim 1 wherein the second transmit power level is a maximum level.

4. The method of claim 1 wherein the another node is a parent node of the child node or a neighboring node of the child node.

5. The method of claim 1 wherein the child node determining that the child node has disconnected from the wireless network includes the child node determining that the child node has lost a connection with all parent nodes of the child node.

6. The method of claim 1 further comprising:
the child node repeatedly increasing the first transmit power level until the child node reconnects to the wireless network.

7. The method of claim 1 further comprising:
the child node repeatedly increasing the first transmit power level until the child node reaches a maximum transmit power level.

8. The method of claim 1 further comprising:
the child node determining whether the child node reconnected to the wireless network; and
when the child node determines that the child node is reconnected to the wireless network, the child node moving to an optimized transmit power level.

9. A method comprising:
a wireless gateway device determining that a child node has disconnected from a wireless network based on a message received from a parent node of the child node;
the wireless gateway device instructing the parent node of the child node to transmit a parent reconnection message to the child node at a first parent transmit power level;
the wireless gateway device instructing the parent node to incrementally increase the first parent transmit power level to a second parent transmit power level when the parent node fails to reconnect to the child node responsive to the parent node transmitting the parent reconnection message to the child node at the first parent transmit power level; and
the wireless gateway device instructing the parent node to transmit the parent reconnection message to the child node at the second parent transmit power level,
wherein the second parent transmit power level is higher than the first parent transmit power level.

10. The method of claim 9 wherein the first parent transmit power level is a baseline level.

11. The method of claim 9 wherein the second parent transmit power level is a maximum level.

12. The method of claim 9 wherein the wireless gateway device determining that the child node has disconnected from the wireless network includes the wireless gateway device determining that the child node has lost a connection with all parent nodes of the child node.

13. The method of claim 9 further comprising:
the wireless gateway device instructing the parent node to repeatedly increase the first parent transmit power level until the wireless gateway device determines that the child node is reconnected to the wireless network.

14. The method of claim 9 further comprising:
the wireless gateway device instructing the parent node to repeatedly increase the first parent transmit power level until the parent node reaches a maximum transmit power level.

15. The method of claim 9 further comprising:
the wireless gateway device storing a list of neighboring nodes that transmit wireless signals detectable by the child node;
the wireless gateway storing a respective signal strength for each of neighboring nodes;
the wireless gateway device instructing a best one of the neighboring nodes to transmit a neighbor connection message to the child node at a first neighbor transmit power level when the parent node fails to reconnect to the child node responsive to the parent node transmitting the parent reconnection message to the child node at the second parent transmit power level;
the wireless gateway device instructing the best one of the neighboring nodes to incrementally increase the first neighbor transmit power level to a second neighbor transmit power level when the best one of the neighboring nodes fails to reconnect to the child node responsive to the best one of the neighboring nodes transmitting the neighbor connection message to the child node at the first neighbor transmit power level; and
the wireless gateway device instructing the best one of the neighboring nodes to transmit the neighbor connection message to the child node at the second neighbor transmit power level,
wherein the best one of the neighboring nodes has a strongest signal strength of each of the neighboring nodes on the list that has not attempted to connect to the child node while the child node is disconnected from the wireless network, and
wherein the second neighbor transmit power level is higher than the first neighbor transmit power level.

16. The method of claim 15 wherein the first neighbor transmit power level is a baseline level.

17. The method of claim 15 wherein the second neighbor transmit power level is a maximum level.

18. The method of claim 15 further comprising:
the wireless gateway device instructing the best one of the neighboring nodes to repeatedly increase the first neighbor transmit power level until the wireless gateway device determines that the child node is reconnected to the wireless network.

19. The method of claim 15 further comprising:
the wireless gateway device instructing the best one of the neighboring nodes to repeatedly increase the first neighbor transmit power level until the best one of the neighboring nodes reaches a maximum transmit power level.

20. A system comprising:
a wireless gateway device for a wireless network;
a parent node wirelessly connected to the wireless gateway device;
a child node of the parent node wirelessly connected to the wireless gateway device via the parent node; and
a neighboring node of the child node wirelessly connected to the wireless gateway device,
wherein, when the child node determines that the child node has disconnected from the wireless network, the child node transmits a first reconnection message to another node in the wireless network at a first child transmit power level,
wherein the child node incrementally increases the first child transmit power level to a second child transmit power level and transmits the first reconnection message at the second child transmit power level when the child node fails to reconnect to the wireless network responsive to the child node transmitting the first reconnection message at the first child transmit power level,
wherein, when the wireless gateway device determines that the child node has disconnected from the wireless network based on a message received from a parent node of the child node, the wireless gateway device instructs the parent node or the neighboring node to transmit a second reconnection message to the child node at a first parent/neighbor transmit power level,
wherein the wireless gateway device instructs the parent node or the neighboring to incrementally increase the first parent/neighbor transmit power level to a second parent/neighbor transmit power level and transmit the second reconnection message to the child node at the second parent/neighbor transmit power level when the parent node and the neighbor node fail to connect to the child node responsive to the parent node or the neighbor node transmitting the second reconnection message to the child node at the first parent/neighbor transmit power level,
wherein the second child transmit power level is higher than the first child transmit power level, and
wherein the second parent/neighbor transmit power level is higher than the first parent/neighbor transmit power level.
